(19) United States
(12) Patent Application Publication
(10) Pub. No.: US 2024/0161586 A1
(43) Pub. Date: May 16, 2024

(54) SERVICE PROVIDING SERVER FOR PROVIDING TOURNAMENT GAME SERVICES THAT SUPPORT PARTICIPATION IN TOURNAMENTS FOR GAMES USING TICKETS AND THE OPERATING METHOD THEREOF

(71) Applicant: Supertree Co., Ltd., Seoul (KR)

(72) Inventor: Sung Wone CHOI, Seoul (KR)

(73) Assignee: Supertree Co., Ltd., Seoul (KR)

(21) Appl. No.: 18/385,868

(22) Filed: Oct. 31, 2023

(30) Foreign Application Priority Data
Nov. 10, 2022 (KR) 10-2022-0149666

(51) Int. Cl. G07F 17/32; G06Q 20/06; G06Q 20/36; G06Q 20/38; G06Q 30/0283; G06Q 30/0645; H04L 9/08; H04L 9/32

(52) U.S. Cl. CPC G07F 17/3276; G06Q 20/065; G06Q 20/36; G06Q 20/3825; G06Q 30/0283; G06Q 30/0645; G07F 17/323; G07F 17/3241; G07F 17/3244; H04L 9/0825; H04L 9/3247; G06Q 2220/00; H04L 2209/56

(57) ABSTRACT

Disclosed are a service providing server for providing tournament game services that support participation in tournaments for games using tickets and the operating method thereof to support users to play the games while competing with each other by a tournament scheme with other users in an online environment.

### CROSS-REFERENCE TO RELATED APPLICATIONS

This application claims priority to and the benefit of Korean Patent Application No. 10-2022-0149666 filed in the Korean Intellectual Property Office on Nov. 10, 2022, the entire contents of which are incorporated herein by reference.

### TECHNICAL FIELD

The present disclosure relates to a service providing server for providing tournament game services that support participation in tournaments for games using tickets and the operating method thereof.

### BACKGROUND ART

Recently, as various electronic terminals including desktop PCs, smart phones, tablet PCs, console game machines, etc., have been released, the number of persons who play games through the electronic terminals has increased.

In particular, the recent electronic terminals provide an environment which enables playing games with others online, in that the electronic terminals enable online connections.

As such, as the environment to play the games with other persons through online is widely spread, an interest in the introduction of a new business model using online-based games is also increasing.

Normally, the online-based games are designed to allow people to compete with each other in an online environment, so it is possible to introduce a predetermined tournament service using the online-based games.

For example, by holding a tournament competition using a number of games so that people participate in the tournament of the game they want, the introduction of a business model that pays a certain reward to the winner who wins a specific tournament competition can be considered.

However, in order to provide a tournament platform service using these games, user management technology needs to be introduced, which allows anybody not to participate in the tournament, but allows only the users who qualify for participating in a predetermined tournament to participate in the tournament to improve the quality of the service.

In this regard, the introduction of service technology can be considered, which allows only predetermined certified members to participate in the tournament, and at the same time, issues a predetermined ticket for participating in the tournament, and allows only the people who purchase this ticket to participate in the tournament of a specific game.

### SUMMARY OF THE INVENTION

The present disclosure has been made in an effort to provide a service providing server for providing tournament game services that support participation in tournaments for games using tickets and the operating method thereof to support users to play the games while competing with each other by a tournament scheme with other users in an online environment.

An exemplary embodiment of the present disclosure provides a service providing server for providing tournament game services that support participation in tournaments for games using ticket, which includes: a game information storage unit storing information on the number of required tickets for participating in tournaments of a plurality of predetermined respective games; a ticket information storage unit storing information on the quantity of holding tickets held by each of a plurality of members which subscribes to the tournament game service; a confirmation unit conducting, when an access request command to a tournament session, wherein the tournament session means a session opened for allowing members accessing the tournament session through the electronic terminal to play the first game online jointly, opened for a first game which is any one of the plurality of games is received from a first electronic terminal which is a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; and a reduction processing unit allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number.

Another exemplary embodiment of the present disclosure provides an operating method of a service providing server for providing tournament game services that support participation in tournaments for games using ticket, which includes: maintaining a game information storage unit storing information on the number of required tickets for participating in tournaments of a plurality of predetermined respective games; maintaining a ticket information storage unit storing information on the quantity of holding tickets held by each of a plurality of members which subscribes in the tournament game service; conducting, when an access request command to a tournament session, wherein the tournament session means a session opened for allowing members accessing to the tournament session through the electronic terminal to play the first game online jointly, opened for a first game which is any one of the plurality of games is received from a first electronic terminal which is a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; and allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number.

According to exemplary embodiment of the present disclosure, provided area a service providing server for providing tournament game services that support participation in tournaments for games using tickets and the operating method thereof to support users to play the games while competing with each other by a tournament scheme with other users in an online environment.

### BRIEF DESCRIPTION OF THE DRAWINGS

FIG. 1 is a diagram illustrating a structure of a service providing server for providing tournament game services that support participation in tournaments for games using tickets according to an exemplary embodiment of the present disclosure.

FIG. 2 is a diagram for describing an operation of the service providing server for providing tournament game services that support participation in tournaments for games using tickets according to an exemplary embodiment of the present disclosure.

FIG. 3 is a flowchart illustrating an operating method of the service providing server for providing tournament game services that support participation in tournaments for games using tickets according to an exemplary embodiment of the present disclosure.

### DETAILED DESCRIPTION

Hereinafter, exemplary embodiments of the present disclosure will be described in detail with reference to the accompanying drawings. The description does not limit the present disclosure to specific exemplary embodiments, and it should be understood that the present disclosure covers all the modifications, equivalents and replacements included within the idea and technical scope of the present disclosure. In describing each drawing, like reference numerals refer to like elements and if not contrarily defined, all terms used herein including technological or scientific terms have the same meanings as those generally understood by a person with ordinary skill in the art.

In this document, unless explicitly described to the contrary, the word “comprise” and variations such as “comprises” or “comprising”, will be understood to imply the inclusion of stated elements but not the exclusion of any other elements. Further, in various exemplary embodiments of the present disclosure, each of the components, functional blocks or means may be constituted by one or more lower components and electrical, electronic, and mechanical functions performed by respective components may be implemented as various known devices or mechanical elements including an electronic circuit, an integrated circuit, an Application Specific Integrated Circuit (ASIC), etc., and the respective components may be separately implemented or two or more components may be integrated into one and implemented.

Meanwhile, blocks of the accompanying block diagram or steps of a flowchart may be appreciated as meaning compute program instructions mounted on a processor or a memory of data processible equipment such as a universal computer, a special computer, a portable notebook computer, a network computer, etc., and performing designated functions. Since the computer program instructions may be stored in a memory provided in a computer device or a computer readable memory, functions described in blocks of a block diagram or steps of a flowchart may be produced as a manufactured object including an instruction mean performing the functions. Moreover, each block or each step may represent a part of a module, a segment, or a code that includes one or more executable instructions for executing a specified logical function(s). It should also be noted that in some replaceable embodiments, the functions mentioned in the blocks or steps may also be executed differently from a predetermined order. For example, two blocks or steps that are subsequently illustrated are substantially simultaneously carried out, or may be performed in a reverse order, and in some cases, the functions may be performed while some blocks or steps are omitted.

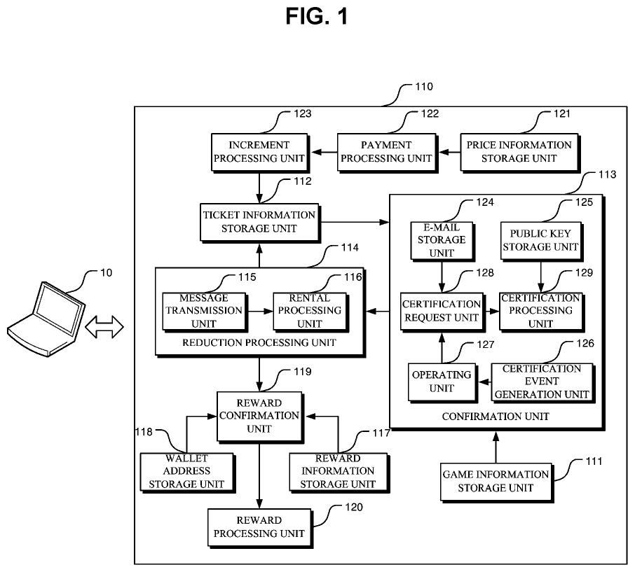

FIG. 1 is a diagram illustrating a structure of a service providing server for providing tournament game services that support participation in tournaments for games using tickets according to an exemplary embodiment of the present disclosure.

Referring to FIG. 1, the service providing server 110 according to the present disclosure may include a game information storage unit 111, a ticket information storage unit 112, a confirmation unit 113, and a reduction processing unit 114.

The game information storage unit 111 stores information on the number of required tickets for participating in tournaments of a plurality of predetermined respective games.

For example, the game information storage unit 111 may store information shown in Table 1 below.

TABLE 1

| Plurality of games | Number of required tickets |
|---|---|
| Game 1 | 2 |
| Game 2 | 1 |
| Game 3 | 5 |
| Game 4 | 7 |
| . . . | . . . |

The ticket information storage unit 112 stores information on the quantity of holding tickets held by each of a plurality of members which subscribes to the tournament game service.

For example, the ticket information storage unit 112 may store information shown in Table 2 below.

TABLE 2

| Plurality of members | Quantity of holding tickets |
|---|---|
| Member 1 | 10 |
| Member 2 | 30 |
| Member 3 | 0 |
| Member 4 | 5 |
| . . . | . . . |

In such a situation, an operator of the service providing server 110 according to the present disclosure may hold a tournament competition for each of the plurality of games in order to provide the tournament game service, and in this case, the operator may open a tournament session of each of the plurality of games online in order to allow the members to participate in the tournament competition for each of the plurality of games online through electronic terminals held by the members.

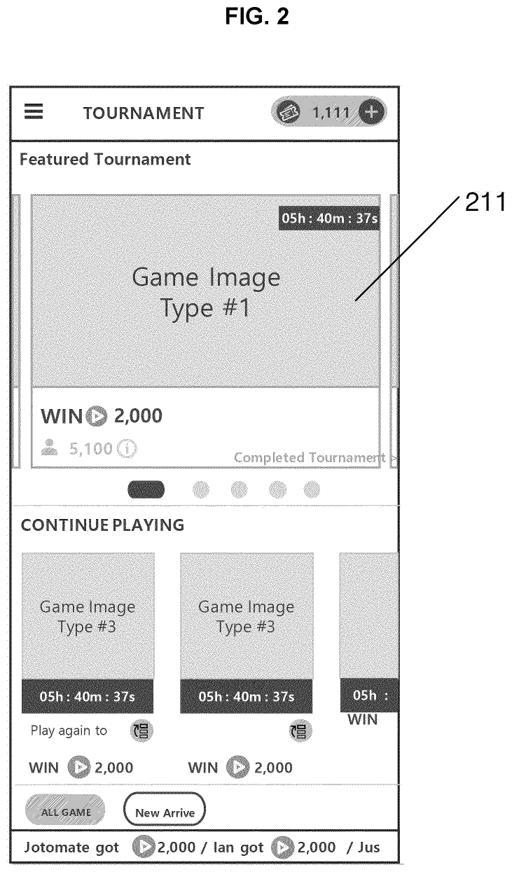

In this regard, FIG. 2 is a diagram illustrating an example of a screen in which when a specific member accesses the service providing server 110 through an electronic terminal thereof, a tournament session of each of the plurality of games is opened, which may be viewed through the electronic terminal. Here, when reference numeral 211 of FIG. 2 represents a screen in which a tournament session for a first game which is any one of the plurality of games is opened, the tournament session means a session opened so as for members who accesses the tournament session to play the first game online together through the electronic terminal. That is, multiple members access the tournament session through electronic terminals thereof to play the first game jointly with each other online.

As a result, when a first member which is any one of the plurality of members accesses the service providing server 110 through a first electronic terminal 10 thereof, the first member may view a waiting room screen having a UI shown in FIG. 2 through the first electronic terminal 10.

In this case, when the first member clicks on the tournament session for the first game represented by reference numeral 211 through the first electronic terminal 10, the first electronic terminal 10 may transmit, to the service providing server 110 of the present disclosure, an access request command to the tournament session.

In this case, when the confirmation unit 113 receives, from the first electronic terminal 10, the access request command to the tournament session opened for the first game, the confirmation unit 113 conducts certification for the first member, and then confirms a first required number which is the number of required tickets for participating in the tournament of the first game by referring to the game information storage unit 111, and confirms the quantity of holding tickets held by the first member by referring to the ticket information storage unit 112.

When it is confirmed that the quantity of holding tickets held by the first member is equal to or more than the first required number, the reduction processing unit 114 allows the first electronic terminal 10 to access the tournament session, and then reduces the quantity of holding tickets for the first member stored in the ticket information storage unit 112 by the first required number.

In this regard, when it is assumed that the information is stored in the game information storage unit 111 as in Table 1 above and the information is stored in the ticket information storage unit 112 as in Table 2 above, and the first game is referred to as ‘game 2 and the first member is referred to as ‘member 4’, since ‘5’ which is the quantity of holding tickets held by ‘member 4’ is equal to or more than ‘1’ which is the first required number to participate in the tournament for ‘game 2’, the reduction processing unit 114 may allow the first electronic terminal 10 to access the tournament session for ‘game 2’, and then reduce the quantity of holding tickets held by ‘member 4’ stored in the ticket information storage unit 112 by ‘1’, and change the quantity of holding tickets to ‘4’.

In this case, according to an exemplary embodiment of the present disclosure, the reduction processing unit 114 may further include a message transmission unit 115 and a rental processing unit 116.

When it is confirmed that the quantity of holding tickets held by the first member is less than the first required number, the message transmission unit 115 calculates the number of necessary tickets, and then when it is confirmed that the number of necessary tickets is less than a predetermined threshold, the message transmission unit 115 generates a guidance message indicating that tickets of the number of necessary tickets may be rented, and transmits the generated guidance message to the first electronic terminal 10.

For example, when the first member is referred to as ‘member 4’ and the first game is referred to as ‘game 4’, ‘5’ which is the quantity of holding tickets held by ‘member 4’ is less than ‘7’ which is the first required number, so the message transmission unit 115 may calculate ‘2’ as the number of necessary tickets, and then confirm whether the number of necessary tickets is less than a predetermined threshold. When the threshold is ‘3’, it is confirmed that the number of necessary tickets is less than the threshold, so the message transmission unit 115 may generate a guidance message indicating that the tickets of the number of necessary tickets may be rented, and transmit the generated guidance message to the first electronic terminal 10. However, when the threshold is ‘2’, it is confirmed that the number of necessary tickets is not less than the threshold, so the message transmission unit 115 may block the access of the first electronic terminal 10 to the tournament session without transmitting the guidance message.

When the guidance message is transmitted to the first electronic terminal 10, and then a rental command of instructing renting the tickets of the number of necessary tickets is received from the first electronic terminal 10 in response to the guidance message, the rental processing unit 116 allows the first electronic terminal 10 to access the tournament session, reduces the quantity of holding tickets for the first member stored in the ticket information storage unit 112 by the first required number, and then when a predetermined rental period elapsed, generates a purchase message which instructs to purchase the tickets of the number of necessary tickets, and transmits the generated purchase message to the first electronic terminal 10.

In this regard, as in the above-described example, when the first member is ‘member 4’, the first game is ‘game 4’, the number of necessary tickets is ‘2’, and the predetermined rental period is ‘3 days’, upon receiving the rental command from the first electronic terminal 10, the rental processing unit 116 may allow the first electronic terminal 10 to access the tournament session for ‘game 4’, and reduce the quantity of holding tickets for ‘member 4’ stored in the ticket information storage unit 112 by ‘7’ which is the first required number, and change the quantity of holding tickets to ‘−2’, and then when ‘3 days’ elapsed, generate the purchase message which instructs to purchase the tickets of the number of necessary tickets, and transmit the generated purchase message to the first electronic terminal 10.

According to an exemplary embodiment of the present disclosure, the service providing server 110 may further include a reward information storage unit 117, a wallet address storage unit 118, a reward confirmation unit 119, and a reward processing unit 120.

The reward information storage unit 117 stores information on the amount of payment of cryptocurrency to be paid as a reward when winning the tournament for each of the plurality of games.

For example, the reward information storage unit 117 may store information as in Table 3 below.

TABLE 3

| Plurality of games | Payment amount of cryptocurrency |
|---|---|
| Game 1 | 5 coins |
| Game 2 | 2 coins |
| Game 3 | 13 coins |
| Game 4 | 20 coins |
| . . . | . . . |

The wallet address storage unit 118 stores information on a wallet address for accumulating cryptocurrency held by each of the plurality of members.

For example, the wallet address storage unit 118 may store information as in Table 4 below.

TABLE 4

| Plurality of members | Wallet address |
|---|---|
| Member 1 | Address 1 |
| Member 2 | Address 2 |
| Member 3 | Address 3 |
| Member 4 | Address 4 |
| . . . | . . . |

When an event occurs, which indicates that the first member is a winner through the tournament session as the first members wins the tournament for the first game after the first member completes participating in the tournament for the first game as the first electronic terminal 10 accesses the tournament session, the reward confirmation unit 119 confirms a first payment amount which is the payment amount of the cryptocurrency to be paid as the reward when winning the tournament for the first game by referring to the reward information storage unit 117, and confirms the wallet address of the first member by referring to the wallet address storage unit 118.

The reward processing unit 120 transfers the crytocurrency of the first payment amount to the wallet address of the first member to complete reward processing for the first member.

In this regard, a situation is assumed in which the first member is ‘member 4’, the first game is ‘game 2’, and as the first electronic terminal 10 accesses the tournament session opened for ‘game 2’, ‘member 4’ completes participating in the tournament for ‘game 2’.

When ‘member 4’ wins the tournament for ‘game 2’, the service providing server 110 may generate an event indicating that ‘member 4’ is the winner through the tournament session opened for ‘game 2’. As such, when the event indicating that ‘member 4’ is the winner is generated through the tournament session opened for ‘game 2’, the reward confirmation unit 119 may confirm that the payment amount of the cryptocurrency to be paid as the reward when winning the tournament for ‘game 2’ is ‘2 coins’ by referring to the reward information storage unit 117, and confirm the wallet address of ‘member 4’ as ‘address 4’ by referring to the wallet address storage unit 118.

Then, the reward processing unit 120 transfers the cryptocurrency as much as ‘2 coins’ to ‘address 4’ which is the wallet address of ‘member 4’ to complete reward processing for ‘member 4’.

Through this, when the members win the tournaments for the games participated thereby, the members may receive the rewards thereof as the cryptocurrency, and will be able to more actively participate in the tournaments for the games due to the reward.

According to an exemplary embodiment of the present disclosure, the service providing server 110 may further include a configuration for allowing the members to purchase tickets for participating in the tournaments. In this regard, the service providing server 110 may further include a price information storage unit 121, a payment processing unit 122, and an increment processing unit 123.

The price information storage unit 121 stores purchase price information of the ticket for participating in the tournament.

For example, the price information storage unit 121 may store purchase price information of ‘5000 won per ticket’ as the purchase price information of the ticket.

Upon receiving the purchase request command of requesting purchasing tickets as many as a first purchase quantity from the first electronic terminal 10, the payment processing unit 122 requests transmission of payment means information to the first electronic terminal 10, and upon receiving first payment means information from the first electronic terminal 10, the payment processing unit 122 calculates a price corresponding to the first purchase quantity based on the purchase price information, and then perform payment processing for the calculated price based on the first payment means information.

For example, when the purchase price information of the ticket is designated as ‘5000 won per ticket’, and the service providing server 110 receives the purchase request command of requesting purchasing ‘5’ tickets from the first electronic terminal 10, the payment processing unit 122 may request transmission of the payment means information to the first electronic terminal 10, and when the service providing server 110 receives credit card information from the first electronic terminal 10 in response thereto, the payment processing unit 122 may calculate a price corresponding to the purchase quantity of ‘5’ tickets as ‘25000 won’ based on the purchase price information, and then perform payment processing for ‘25000 won’ based on the credit card information.

When the payment processing is completed through the payment processing unit 122, the increment processing unit 123 increases the quantity of holding tickets for the first member stored in the ticket information storage unit 112 by the first purchase quantity.

According to an exemplary embodiment of the present disclosure, upon receiving the access request command to the tournament session opened for the first game from the first electronic terminal 10 of the first member, the service providing server 110 performs the certification for the first member, and then only when it is confirmed that the first member is a certified member, the service providing server 110 may further include a configuration of conducting a process for determining whether to allow the first electronic terminal 10 to access the tournament session based on the ticket held by the first member.

To this end, the confirmation unit 113 may include an e-mail storage unit 124, a public key storage unit 125, a certification event generation unit 126, an operating unit 127, a certification request unit 128, and a certification processing unit 129.

The e-mail storage unit 124 stores information on a predetermined e-mail address for each of the plurality of members.

In this regard, the e-mail storage unit 124 may store information as in Table 5 below.

TABLE 5

| Plurality of members | E-mail address |
|---|---|
| Member 1 | E-mail address 1 |
| Member 2 | E-mail address 2 |
| Member 3 | E-mail address 3 |
| Member 4 | E-mail address 4 |
| . . . | . . . |

The public key storage unit 125 stores a public key corresponding to a private key pre-issued for each of the plurality of members. Here, the private key for each of the plurality of members is stored in the electronic terminal of each member.

In this regard, the public key storage unit 125 may store information as in Table 6 below.

TABLE 6

| Plurality of members | Public key |
|---|---|
| Member 1 | Public key 1 |
| Member 2 | Public key 2 |
| Member 3 | Public key 3 |
| Member 4 | Public key 4 |
| . . . | . . . |

The certification event generation unit 126 generates a certification event for conducting the certification for the first member when receiving the access request command to the tournament session from the first electronic terminal 10.

The operating unit 127 randomly generates an n (n is a natural number of 2 or more)-digit first certification number and an n-digit second certification number, and then generates a column vector having respective digit numbers constituting the first certification number as components and a row vector having respective digit numbers constituting the second certification number as components, and operates a matrix multiplication between the column vector and the row vector to generate an operation matrix of an n×n size, and then operates Frobenius Norm of the operation matrix.

For example, when n is ‘3’, the operating unit 127 randomly generates the 3-digit first certification number and second certification number as ‘642’ and ‘251’, respectively, and then generates a column vector having respective digit numbers constituting ‘642’ which is the first certification number as components as

$$‘ [ \begin{matrix}6 \\ 4 \\ 2\end{matrix} ] ’$$

and generates a row vector having respective digit numbers constituting ‘251’ which is the second certification number as components as ‘[2 5 1]’, and then operates the matrix multiplication between the column vector and the row vector to generate an operation matrix of a 3×3 size as

$$‘ [ \begin{matrix}12 & 30 & 6 \\ 8 & 20 & 4 \\ 4 & 10 & 2\end{matrix} ] ’ .$$

Then, the operating unit 127 may operate the Frobenius Norm of the operation matrix as ‘40.98’.

The certification request unit 128 confirms a first e-mail address for the first member by referring to the e-mail storage unit 124, sends a certification e-mail including the first certification number with the first e-mail address as a receiving side, and then transmits the second certification number to the first electronic terminal 10, and at the same time, requests an electronic signature based on the first certification number and the second certification number.

For example, as in the above-described example, when the first certification number and the second certification number are ‘642’ and ‘251’, respectively, and the first member is ‘member 4’, the certification request unit 128 may refer to the e-mail storage unit 124 shown in Table 5, confirm ‘e-mail address 4’ for ‘member 4’, and send the certification e-mail including ‘642’ which is the first certification number with ‘e-mail address 4’ as the receiving side. Then, the certification request unit 128 may transmit ‘251’ which is the second certification number to the first electronic terminal 10, and at the same time, request the electronic signature based on the first certification number and the second certification number.

In this case, according to an exemplary embodiment of the present disclosure, upon receiving the electronic signature request from the service providing server 110 jointly with the second certification number, the first electronic terminal 10 may display a message for requesting the first member to input the first certification number included in the certification e-mail received by an account according to the first e-mail address into the first electronic terminal 10.

In this case, when the first member inputs, into the first electronic terminal 10, the first certification number included in the certification e-mail received by the account according to the first e-mail address in response to the message, the first electronic terminal 10 may generate a column vector having respective digit numbers constituting the first certification number as components and a row vector having respective digit numbers constituting the second certification number as components, and operate the matrix multiplication between the column vector and the row vector to generate the operation matrix of the n×n size, and then sign the Frobenius Norm of the operation matrix with the first private key for the first member stored in the first electronic terminal 10 to generate a first electronic signature value, and transmit the generated first electronic signature value to the service providing server 110 of the present disclosure.

In this regard, as in the above-described example, when the first certification number and the second certification number are ‘642’ and ‘251’, respectively, and the first member is ‘member 4’, the first electronic terminal 10 may display a message for requesting ‘member 4’ to input the first certification number included in the certification e-mail received by the account according to ‘e-mail address 4’ into the first electronic terminal 10 when receiving the electronic signature request from the service providing server 110 jointly with ‘251’ which is the second certification number.

Then, ‘member 4’ logs into the account according to ‘e-mail address 4’ to confirm the certification e-mail, and confirms ‘642’ which is the first certification number included in the certification e-mail to input the ‘642’ into the first electronic terminal 10.

As such, when ‘member 4’ inputs ‘642’ which is the first certification number included in the certification e-mail into the first electronic terminal 10, the first electronic terminal 10 generates a column vector having respective digit numbers constituting ‘642’ which is the first certification number as components as

$$‘ [ \begin{matrix}6 \\ 4 \\ 2\end{matrix} ] ’$$

and generates a row vector having respective digit numbers constituting ‘251’ which is the second certification number as components as ‘[2 5 1]’, and then operates the matrix multiplication between the column vector and the row vector to generate an operation matrix of a 3×3 size as

$$‘ [ \begin{matrix}12 & 30 & 6 \\ 8 & 20 & 4 \\ 4 & 10 & 2\end{matrix} ] ’ .$$

Then, the first electronic terminal 10 operates the Frobenius Norm of the operation matrix as ‘40.98’, and then performs the electronic signature for ‘40.98’ which is the Frobenius Norm based on ‘private key 4’ which is the private key for ‘member 4’ pre-stored in the first electronic terminal 10 to generate the first electronic signature value and transmit the first electronic signature value to the service providing server 110 of the present disclosure.

Upon receiving the first electronic signature value in response to the electronic signature request from the first electronic terminal 10, the certification processing unit 129 extracts a first public key for the first member from the public key storage unit 125, and then compares a value acquired by decoding the first electronic signature value based on the first public key and the Frobenius Norm of the operation matrix with each other, and when it is confirmed that both values coincide with each other, completes the certification for the first member.

In this regard, as in the above-described example, when the first member is ‘member 4’ and the Frobenius Norm of the operation matrix is ‘40.98’, the certification processing unit 129 may extract ‘public key 4’ which is a public key for ‘member 4’ from the public key storage unit 125 as in Table 6 above, and then decode the first electronic signature value based on ‘public key 4’, upon receiving the first electronic signature value from the first electronic terminal 10.

Thereafter, the certification processing unit 129 may compare a decoding value for the first electronic signature value and ‘40.98’ which is the Frobenius Norm of the operation matrix with each other, and when it is confirmed that both values coincide with each other, complete the certification for ‘member 4’.

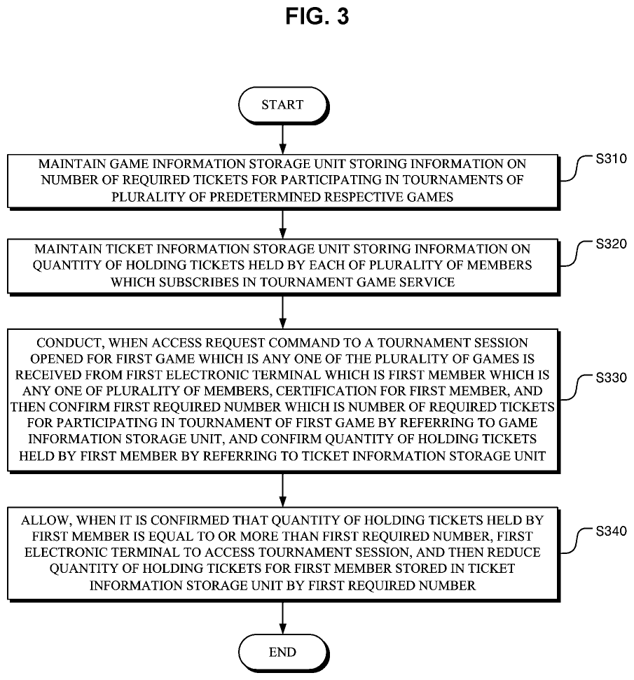

FIG. 3 is a flowchart illustrating an operating method of the service providing server for providing tournament game services that support participation in tournaments for games using tickets according to an exemplary embodiment of the present disclosure.

In step S310, a game information storage unit is maintained, which stores information on the number of required tickets for participating in tournaments of a plurality of predetermined respective games.

In step S320, a ticket information storage unit is maintained, which stores information on the quantity of holding tickets held by each of a plurality of members which subscribes to the tournament game service.

In step S330, when an access request command to a tournament session (the tournament session means a session opened for allowing members accessing the tournament session through the electronic terminal to play the first game online jointly) opened for a first game which is any one of the plurality of games is received from a first electronic terminal which is a first member which is any one of the plurality of members, certification for the first member is conducted, and then a first required number which is the number of required tickets for participating in the tournament of the first game is confirmed by referring to the game information storage unit, and the quantity of holding tickets held by the first member is confirmed by referring to the ticket information storage unit.

In step S340, when it is confirmed that the quantity of holding tickets held by the first member is equal to or more than the first required number, the first electronic terminal is allowed to access the tournament session, and then the quantity of holding tickets for the first member stored in the ticket information storage unit is reduced by the first required number.

In this case, according to an exemplary embodiment of the present disclosure, step S340 may include a step of calculating, when it is confirmed that the quantity of holding tickets held by the first member is less than the first required number, the number of necessary tickets, and then when it is confirmed that the number of necessary tickets is less than a predetermined threshold, generating a guidance message indicating that the tickets of the number of necessary tickets may be rented and transmitting the guidance message to the first electronic terminal, and a step of allowing, when a rental command of instructing renting the tickets of the number of necessary tickets is received from the first electronic terminal in response to the guidance message, the first electronic terminal to access the tournament session, and reducing the quantity of holding tickets for the first member stored in the ticket information storage unit by the first required number, and then generating, when a predetermined rental period elapsed, a purchase message which instructs to purchase the tickets of the number of necessary tickets, and transmitting the purchase message to the first electronic terminal.

According to an exemplary embodiment of the present disclosure, the operating method of the service providing server may further include a step of maintaining a reward information storage unit storing information on the amount of payment of cryptocurrency to be paid as a reward when winning the tournament for each of the plurality of games, a step of maintaining a wallet address storage unit storing information on a wallet address for accumulating cryptocurrency held by each of the plurality of members, a step of confirming, when an event occurs, which indicates that the first member is a winner through the tournament session as the first members wins the tournament for the first game after the first member completes participating in the tournament for the first game as the first electronic terminal accesses the tournament session, a first payment amount which is the payment amount of the crytocurrency to be paid as the reward when winning the tournament for the first game by referring to the reward information storage unit, and confirming the wallet address of the first member by referring to the wallet address storage unit, and a step of transferring the crytocurrency of the first payment amount to the wallet address of the first member to complete reward processing for the first member.

According to an exemplary embodiment of the present disclosure, the operating method of the service providing server may further include a step of maintaining a price information storage unit storing purchase price information of the ticket for participating in the tournament, a step of requesting, upon receiving the purchase request command of requesting purchasing tickets as many as a first purchase quantity from the first electronic terminal, transmission of payment means information to the first electronic terminal, and upon receiving first payment means information from the first electronic terminal, calculating a price corresponding to the first purchase quantity based on the purchase price information, and then performing payment processing for the calculated price based on the first payment means information, and a step of increasing, when the payment processing is completed, the quantity of holding tickets for the first member stored in the ticket information storage unit by the first purchase quantity.

According to an exemplary embodiment of the present disclosure, step S330 may include a step of maintaining an e-mail storage unit storing information on a predetermined e-mail address for each of the plurality of members, a step of maintaining a public key storage unit storing a public key corresponding to a private key—the private key for each of the plurality of members is stored in the electronic terminal of each member—pre-issued for each of the plurality of members, a step of generating a certification event for conducting the certification for the first member when receiving the access request command to the tournament session from the first electronic terminal, a step of randomly generating an n (n is a natural number of 2 or more)-digit first certification number and an n-digit second certification number, and then generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix, a step of confirming a first e-mail address for the first member by referring to the e-mail storage unit, sending a certification e-mail including the first certification number with the first e-mail address as a receiving side, and then transmitting the second certification number to the first electronic terminal, and at the same time, requesting an electronic signature based on the first certification number and the second certification number, and a step of extracting, upon receiving the first electronic signature value (the first electronic signature value is generated as when the second certification number is received by the first electronic terminal, and the first member inputs, into the first electronic terminal, the first certification number included in the certification e-mail received by the account according to the first e-mail address, the first electronic terminal generates a column vector having respective digit numbers constituting the first certification number as components and a row vector having respective digit numbers constituting the second certification number as components, and operates the matrix multiplication between the column vector and the row vector to generate the operation matrix of the n×n size, and then signs the Frobenius Norm of the operation matrix with the first private key for the first member stored in the first electronic terminal) in response to the electronic signature request from the first electronic terminal, a first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

Hereinabove, referring to FIG. 3, the operating method of the service providing server according to an exemplary embodiment of the present disclosure is described. Here, since the operating method of the service providing server according to an exemplary embodiment of the present disclosure may correspond to the configuration of the operation of the service providing server 110 described by using FIG. 1, a more detailed description thereof will be omitted.

The operating method of the service providing server according to an exemplary embodiment of the present disclosure may be implemented by a computer program stored in a storage medium for executing the computer program through coupling with a computer.

The operating method of the service providing server according to an exemplary embodiment of the present disclosure may be implemented in a program command type which may be performed through various computer means and recorded in a computer readable medium. The computer readable medium may include a program command, a data file, a data structure, etc., singly or combinationally. The program command recorded in the medium may be specially designed and configured for the present disclosure, or may be publicly known to and used by those skilled in the computer software field. An example of the computer readable recording medium includes magnetic media, such as a hard disk, a floppy disk, and a magnetic tape, optical media such as a CD-ROM and a DVD, magneto-optical media such as a floptical disk, and hardware devices such as a ROM, a RAM, and a flash memory, which are specially configured to store and execute the program command. An example of the program command includes a high-level language code executable by a computer by using an interpreter and the like, as well as a machine language code created by a compiler.

As described above, the present disclosure has been described by specified matters such as detailed components, and the like and limited exemplary embodiments and drawings, but the description is just provided to assist more overall understanding of the present disclosure and the present disclosure is not limited to the exemplary embodiment and various modifications and changes can be made by those skilled in the art from such a disclosure.

Accordingly, the spirit of the present disclosure should not be defined only by the described exemplary embodiments, and it should be appreciated that claims to be described below and all things which are equivalent to the claims or equivalently modified to the claims are included in the scope of the spirit of the present disclosure.

What is claimed is:

1. A service providing server for providing tournament game services that support participation in tournaments for games using ticket, comprising:
a game information storage unit storing information on the number of required tickets for participating in tournaments of a plurality of predetermined respective games;
a ticket information storage unit storing information on the quantity of holding tickets held by each of a plurality of members which subscribes in the tournament game service;
a confirmation unit conducting, when an access request command to a tournament session, wherein the tournament session means a session opened for allowing members accessing to the tournament session through the electronic terminal to play a first game online jointly, opened for the first game which is any one of the plurality of games is received from a first electronic terminal which is a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; and
a reduction processing unit allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number.

2. The service providing server of claim 1, wherein the reduction processing unit includes
a message transmission unit calculating, when it is confirmed that the quantity of holding tickets held by the first member is less than the first required number, the number of necessary tickets, and then when it is confirmed that the number of necessary tickets is less than a predetermined threshold, generating a guidance message indicating that tickets of the number of necessary tickets may be rented, and transmitting the generated guidance message to the first electronic terminal, and
a rental processing unit allowing, when a rental command instructing to rent the tickets of the number of necessary tickets is received from the first electronic terminal in response to the guidance message, the first electronic terminal to access the tournament session, reducing the quantity of holding tickets for the first member stored in the ticket information storage unit by the first required number, and then when a predetermined rental period elapsed, generating a purchase message which instructs to purchase the tickets of the number of necessary tickets, and transmitting the generated purchase message to the first electronic terminal.

3. The service providing server of claim 1, further comprising:
a reward information storage unit storing information on the amount of payment of cryptocurrency to be paid as a reward when winning the tournament for each of the plurality of games;
a wallet address storage unit storing information on a wallet address for accumulating cryptocurrency held by each of the plurality of members;
a reward confirmation unit confirming, when an event occurs, which indicates that the first member is a winner through the tournament session as the first members wins the tournament for the first game after the first member completes participating in the tournament for the first game as the first electronic terminal accesses the tournament session, a first payment amount which is the payment amount of the crytocurrency to be paid as the reward when winning the tournament for the first game by referring to the reward information storage unit, and confirming the wallet address of the first member by referring to the wallet address storage unit; and
a reward processing unit transferring the crytocurrency of the first payment amount to the wallet address of the first member to complete reward processing for the first member.

4. The service providing server of claim 1, further comprising:
a price information storage unit storing purchase price information of the ticket for participating in the tournament;
a payment processing unit requesting, upon receiving the purchase request command of requesting purchasing tickets as many as a first purchase quantity from the first electronic terminal, transmission of payment means information to the first electronic terminal, and upon receiving first payment means information from the first electronic terminal, calculating a price corresponding to the first purchase quantity based on the purchase price information, and then performing payment processing for the calculated price based on the first payment means information; and
an increment processing unit increasing, when the payment processing is completed, the quantity of holding tickets for the first member stored in the ticket information storage unit by the first purchase quantity.

5. The service providing server of claim 1, wherein the confirmation unit includes
an e-mail storage unit storing information on a predetermined e-mail address for each of the plurality of members,
a public key storage unit storing a public key corresponding to a private key, wherein the private key for each of the plurality of members is stored in the electronic terminal of each member, pre-issued for each of the plurality of members,
a certification event generation unit generating a certification event for conducting the certification for the first member when receiving the access request command to the tournament session from the first electronic terminal,
an operating unit randomly generating a n, wherein n is a natural number of 2 or more, digit first certification number and an n-digit second certification number, and then generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
a certification request unit confirming a first e-mail address for the first member by referring to the e-mail storage unit, sending a certification e-mail including the first certification number with the first e-mail address as a receiving side, and then transmitting the second certification number to the first electronic terminal, and at the same time, requesting an electronic signature based on the first certification number and the second certification number, and
a certification processing unit extracting, upon receiving a first electronic signature value, wherein the first electronic signature value is generated as when the second certification number is received by the first electronic terminal, and the first member inputs, into the first electronic terminal, the first certification number included in the certification e-mail received by the account according to the first e-mail address, the first electronic terminal generates a column vector having respective digit numbers constituting the first certification number as components and a row vector having respective digit numbers constituting the second certification number as components, and operates the matrix multiplication between the column vector and the row vector to generate the operation matrix of the n×n size, and then signs the Frobenius Norm of the operation matrix with the first private key for the first member stored in the first electronic terminal, in response to the electronic signature request from the first electronic terminal, a first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

6. An operating method of a service providing server for providing tournament game services that support participation in tournaments for games using ticket, comprising:
maintaining a game information storage unit storing information on the number of required tickets for participating in tournaments of a plurality of predetermined respective games;
maintaining a ticket information storage unit storing information on the quantity of holding tickets held by each of a plurality of members which subscribes in the tournament game service;
conducting, when an access request command to a tournament session, wherein the tournament session means a session opened for allowing members accessing to the tournament session through the electronic terminal to play a first game online jointly, opened for the first game which is any one of the plurality of games is received from a first electronic terminal which is a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; and
allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number.

7. The operating method of a service providing server of claim 6, wherein the reducing includes
calculating, when it is confirmed that the quantity of holding tickets held by the first member is less than the first required number, the number of necessary tickets, and then when it is confirmed that the number of necessary tickets is less than a predetermined threshold, generating a guidance message indicating that tickets of the number of necessary tickets may be rented, and transmitting the generated guidance message to the first electronic terminal, and
allowing, when a rental command instructing to rent the tickets of the number of necessary tickets is received from the first electronic terminal in response to the guidance message, the first electronic terminal to access the tournament session, reduces the quantity of holding tickets for the first member stored in the ticket information storage unit by the first required number, and then when a predetermined rental period elapsed, generating a purchase message which instructs to purchase the tickets of the number of necessary tickets, and transmitting the generated purchase message to the first electronic terminal.

8. The operating method of a service providing server of claim 6, further comprising:
maintaining a reward information storage unit storing information on the amount of payment of cryptocurrency to be paid as a reward when winning the tournament for each of the plurality of games;
maintaining a wallet address storage unit storing information on a wallet address for accumulating cryptocurrency held by each of the plurality of members;
confirming, when an event occurs, which indicates that the first member is a winner through the tournament session as the first members wins the tournament for the first game after the first member completes participating in the tournament for the first game as the first electronic terminal accesses the tournament session, a first payment amount which is the payment amount of the crytocurrency to be paid as the reward when winning the tournament for the first game by referring to the reward information storage unit, and confirming the wallet address of the first member by referring to the wallet address storage unit; and
transferring the crytocurrency of the first payment amount to the wallet address of the first member to complete reward processing for the first member.

9. The operating method of a service providing server of claim 6, further comprising:
maintaining a price information storage unit storing purchase price information of the ticket for participating in the tournament;
requesting, upon receiving the purchase request command of requesting purchasing tickets as many as a first purchase quantity from the first electronic terminal, transmission of payment means information to the first electronic terminal, and upon receiving first payment means information from the first electronic terminal, calculating a price corresponding to the first purchase quantity based on the purchase price information, and then performing payment processing for the calculated price based on the first payment means information; and
increasing, when the payment processing is completed, the quantity of holding tickets for the first member stored in the ticket information storage unit by the first purchase quantity.

10. The operating method of a service providing server of claim 6, wherein the conducting includes
maintaining an e-mail storage unit storing information on a predetermined e-mail address for each of the plurality of members,
maintaining a public key storage unit storing a public key corresponding to a private key, wherein the private key for each of the plurality of members is stored in the electronic terminal of each member, pre-issued for each of the plurality of members,
generating a certification event for conducting the certification for the first member when receiving the access request command to the tournament session from the first electronic terminal,
randomly generating a n (n is a natural number of 2 or more)-digit first certification number and an n-digit second certification number, and then generating a column vector having respective digit numbers constituting the first certification number as components and a row vector having respective digit numbers constituting the second certification number as components, and operating a matrix multiplication between the column vector and the row vector to generate an operation matrix of an n×n size, and then operating Frobenius Norm of the operation matrix,
confirming a first e-mail address for the first member by referring to the e-mail storage unit, sending a certification e-mail including the first certification number with the first e-mail address as a receiving side, and then transmitting the second certification number to the first electronic terminal, and at the same time, requesting an electronic signature based on the first certification number and the second certification number, and
extracting, upon receiving the first electronic signature value, wherein the first electronic signature value is generated as when the second certification number is received by the first electronic terminal, and the first member inputs, into the first electronic terminal, the first certification number included in the certification e-mail received by the account according to the first e-mail address, the first electronic terminal generates a column vector having respective digit numbers constituting the first certification number as components and a row vector having respective digit numbers constituting the second certification number as components, and operates the matrix multiplication between the column vector and the row vector to generate the operation matrix of the n×n size, and then signs the Frobenius Norm of the operation matrix with the first private key for the first member stored in the first electronic terminal, in response to the electronic signature request from the first electronic terminal, a first public key for the first member from the public key storage unit, and then comparing a value acquired by decoding the first electronic signature value based on the first public key and the Frobenius Norm of the operation matrix with each other, and when it is confirmed that both values coincide with each other, completing the certification for the first member.

11. A non-transitory computer readable recording medium having a program recorded therein for allowing a computer to execute an operating method of a service providing server for providing tournament game services that support participation in tournaments for games using ticket, comprising:
maintaining a game information storage unit storing information on the number of required tickets for participating in tournaments of a plurality of predetermined respective games;
maintaining a ticket information storage unit storing information on the quantity of holding tickets held by each of a plurality of members which subscribes in the tournament game service;
conducting, when an access request command to a tournament session, wherein the tournament session means a session opened for allowing members accessing to the tournament session through the electronic terminal to play a first game online jointly, opened for the first game which is any one of the plurality of games is received from a first electronic terminal which is a first member which is any one of the plurality of members, certification for the first member, and then confirming a first required number which is the number of required tickets for participating in the tournament of the first game by referring to the game information storage unit, and confirming the quantity of holding tickets held by the first member by referring to the ticket information storage unit; and
allowing, when it is confirmed that the quantity of holding tickets held by the first member is equal to or more than the first required number, the first electronic terminal to access the tournament session, and then reducing the quantity of holding tickets for the first member stored in the ticket information storage unit by the first required number.
